(19) United States
(12) Patent Application Publication
(10) Pub. No.: US 2024/0182067 A1
(43) Pub. Date: Jun. 6, 2024

(54) METHODS AND APPARATUS FOR DETECTING AND RESOLVING CONTEXT MAP INCONSISTENCIES FOR AUTONOMOUS VEHICLES

(71) Applicant: Nuro, Inc., Mountain View, CA (US)

(72) Inventors: Gregory Long, Mountain View, CA (US); Zhiqiang SUI, San Jose, CA (US)

(73) Assignee: Nuro, Inc., Mountain View, CA (US)

(21) Appl. No.: 18/476,807

(22) Filed: Sep. 28, 2023

Related U.S. Application Data
(60) Provisional application No. 63/430,588, filed on Dec. 6, 2022.

(51) Int. Cl. B60W 60/00; G01C 21/00

(52) U.S. Cl. CPC B60W 60/001; G01C 21/3822; B60W 2510/18

(57) ABSTRACT

According to one aspect, a method includes operating a vehicle in a first environment, the vehicle including a change detection system and at least one sensor configured to obtain data associated with the first environment, wherein operating the vehicle in the first environment includes obtaining the data associated with the first environment using the at least one sensor. The method also includes obtaining a context map associated with the first environment and comparing, using the change detection system, the data associated with the first environment and the context map to identify at least a first inconsistency between the data associated with the first environment and the context map. While the vehicle is operating, a resolution for the first inconsistency is determined, and the vehicle takes an action based on the resolution.

### PRIORITY CLAIM

This patent application claims the benefit of priority under 35 U.S.C. § 119 to U.S. Provisional Patent Application No. 63/430,588, filed Dec. 6, 2022, and entitled “METHODS AND APPARATUS FOR DETECTING AND RESOLVING CONTEXT MAP INCONSISTENCIES FOR AUTONOMOUS VEHICLES,” which is incorporated herein by reference in its entirety.

### TECHNICAL FIELD

The disclosure relates to providing systems for facilitating the operation of autonomous vehicles. More particularly, the disclosure relates to processing and resolving inconsistencies detected by autonomous vehicles during operation.

### BACKGROUND

Autonomous vehicles utilize context maps, e.g., maps which show the environment associated with roads, to enable routing and localization to be accurate. The maps typically provide detailed information relating to roads. The detailed information often includes road signs, traffic signs, and lane information. When the maps are not accurate, navigational errors may occur when an autonomy system of a vehicle attempts to navigate using the maps. Further, when an inaccurate map is used, safety issues may arise.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic representation of a process flow associated with the identification of an inconsistency that is resolved by a vehicle in accordance with an embodiment.

FIG. 4B is a diagrammatic representation of a process flow associated with the identification of an inconsistency that is resolved by a teleoperations system, e.g., teleoperations system 454 of FIG. 4A, and allows for a vehicle, e.g., vehicle 401 of FIG. 4A, to resume operations in accordance with an embodiment.

FIG. 4C is a diagrammatic representation of a process flow associated with the identification of an inconsistency that is resolved by a teleoperations system, e.g., teleoperations system 454 of FIG. 4A, and results in a vehicle, e.g., vehicle 401 of FIG. 4A, being extracted in accordance with an embodiment.

FIG. 5 is a block diagram representation of a change detection system in accordance with an embodiment.

FIG. 6 is a process flow diagram which illustrates a method of identifying a missing context map feature in accordance with an embodiment.

FIG. 7 is a process flow diagram which illustrates a method of identifying an extraneous context map feature in accordance with an embodiment.

FIG. 8 is a block diagram representation of a teleoperations system, e.g., teleoperations system 454 of FIGS. 4A-C, in accordance with an embodiment.

FIG. 9 is a diagrammatic representation of an overall system within which inconsistencies between an actual environment and a context map are identified and processed in accordance with an embodiment.

FIG. 10 is a diagrammatic representation of a process flow associated with the identification of an inconsistency that is resolved by a vehicle that is part of an enterprise that does not include a teleoperation arrangement or system in accordance with an embodiment.

### DESCRIPTION OF EXAMPLE EMBODIMENTS

### General Overview

According to one embodiment, a method includes operating a vehicle in a first environment, the vehicle including a change detection system and at least one sensor configured to obtain data associated with the first environment, wherein operating the vehicle in the first environment includes obtaining the data associated with the first environment using the at least one sensor. The method also includes obtaining a context map associated with the first environment and comparing, using the change detection system, the data associated with the first environment and the context map to identify at least a first inconsistency between the data associated with the first environment and the context map. While the vehicle is operating, a resolution for the first inconsistency is determined, and the vehicle takes an action based on the resolution.

In another embodiment, a vehicle includes logic encoded in one or more tangible non-transitory, computer-readable media for execution and when executed operable to operate the vehicle in a first environment, the vehicle including a change detection system and at least one sensor configured to obtain data associated with the first environment, wherein the logic operable to operate the vehicle in the first environment is further operable to obtain the data associated with the first environment using the at least one sensor. The logic is also operable to obtain a context map associated with the first environment and to compare, using the change detection system, the data associated with the first environment and the context map to identify at least a first inconsistency between the data associated with the first environment and the context map. Finally, the vehicle includes logic operable to determine, while the vehicle is operating, a resolution for the first inconsistency and logic operable to take an action based on the resolution, wherein the action is taken by the vehicle.

In still another embodiment, a framework includes at least a first vehicle, a teleoperations arrangement, and an enterprise system. The first vehicle includes a change detection system and at least one sensor configured to obtain data while the first vehicle operates, the first vehicle further being arranged to access a context map, wherein the change detection system arranged to compare the data to the context map to identify a first inconsistency. The teleoperations arrangement is configured to monitor the first vehicle, wherein the first vehicle is arranged to provide information associated with the first inconsistency to the first vehicle, the teleoperations arrangement further being configured to determine a first resolution to the first inconsistency and to provide the first resolution to the first vehicle, the first vehicle further being arranged to take an action in response to the first resolution. The enterprise system is configured to maintain the context map, wherein the teleoperations arrangement is arranged to provide the information associated with the first inconsistency and the first resolution to the enterprise system.

A vehicle that is operating autonomously using a context map may encounter an anomaly or inconsistency associated with what is effectively depicted in the context map and what is sensed by sensors of the vehicle in an environment. When an anomaly or inconsistency is encountered, the vehicle may use an onboard map change detection system to assess the anomaly or inconsistency, and to resolve the anomaly or inconsistency. The map change detection system may determine a relevance of a feature associated with the anomaly and probabilities associated with a missing feature or an extraneous feature. Using the relevance and one or more probabilities, the map change detection system may determine how to address the anomaly. Resolving the anomaly onboard the vehicle enables the vehicle to operate efficiently and safely.

### Description

When vehicles drive or otherwise navigate autonomously, context maps are used by autonomous systems to effectively plan how the vehicle will drive. The context maps are generally maps which show features associated with roads traversed by vehicles, and may be labelled to identify features including, but not limited to including, lanes, road signs, and traffic signs. For example, context maps may identify stop signs positioned along roads to indicate where vehicles traveling on the roads are expected to stop.

Features associated with roads may change over time. By way of example, a road may include a stop sign at an earlier point in time, but at a later point in time, the stop sign may be removed. Similarly, a road may not include a stop sign at an earlier point in time, but may include a stop sign at a later point in time. Thus, a map such as a context map that may have been relatively accurate at one point in time may not be as accurate at a later point in time due to changes in features associated with roads.

A context map may describe a geographic region in which a vehicle may operate autonomously. Generally, a context map may include, but is not limited to including, information relating to traversable roads, speed limits, geographic or environmental features, landmarks in the geographic region, etc. The context map may also include information relating to traffic features such as traffic signage, traffic signals or lights, lane markers, pedestrian crossings, and the like. Traffic signage may include, but is not limited to including, stop signs, yield signs, speed limit signs, pedestrian crossing signs, etc.

By identifying inconsistencies or discrepancies between a context map and an actual environment when a vehicle is in the actual environment, the inconsistencies or discrepancies may be resolved substantially in real-time. As a result, the vehicle may continue to operate without compromising safety even in the event that there is an inconsistency in a context map. A system that identifies and resolves inconsistencies may be present onboard a vehicle, and may relatively quickly resolve inconsistencies such that any disruption in the operation of the vehicle may effectively be minimized. In one embodiment, an inconsistency may be resolved by a teleoperations arrangement which is arranged to monitor the vehicle, and to remotely operate the vehicle using teleoperations as appropriate. In another embodiment, an inconsistency may be resolved by the vehicle, and the vehicle may cause an onboard autonomy system to operate in a manner consistent with the resolution identified by the vehicle.

An inconsistency or a discrepancy may be characterized as a feature that appears in an actual environment, but is not accounted for or otherwise does not appear in a context map that corresponds to the environment. An inconsistency or a discrepancy may also be characterized as a missing feature in an actual environment that is accounted for or otherwise appears in a context map that corresponds to the environment. A feature may occupy a space or a location in an actual environment, while a missing feature may effectively be absent from a space or a location in an actual environment.

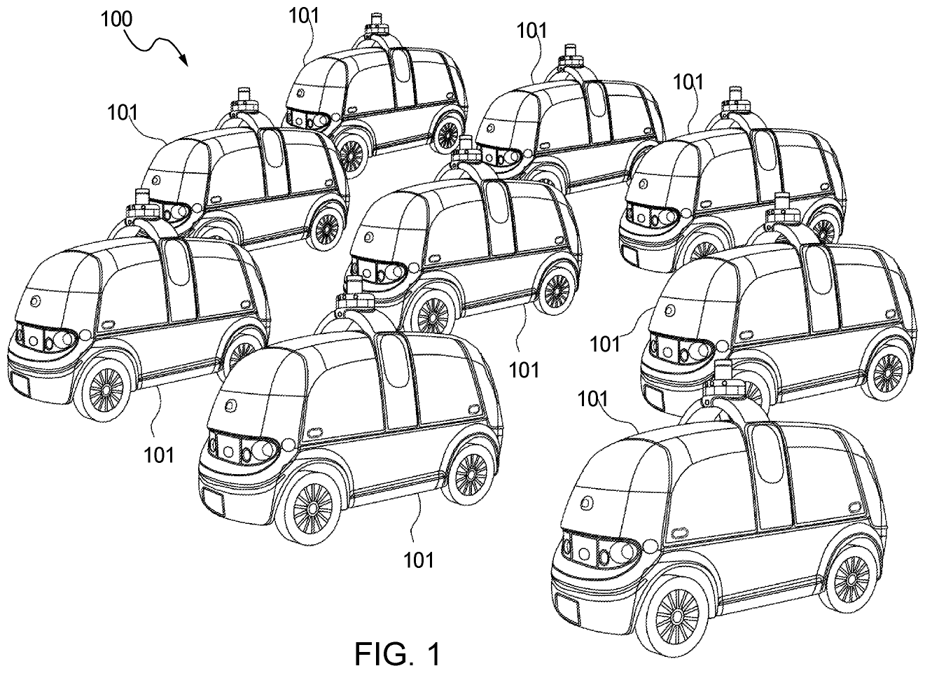

Autonomous vehicles which are capable of identifying and resolving inconsistencies associated with context maps may be occupant-less or may carry occupants, and may be part of an autonomous vehicle fleet. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101, as shown, are generally arranged to transport and/or to deliver cargo, items, and/or goods. However, it should be appreciated that autonomous vehicle fleet 100 may additionally, or alternatively, include vehicles arranged to transport occupants. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

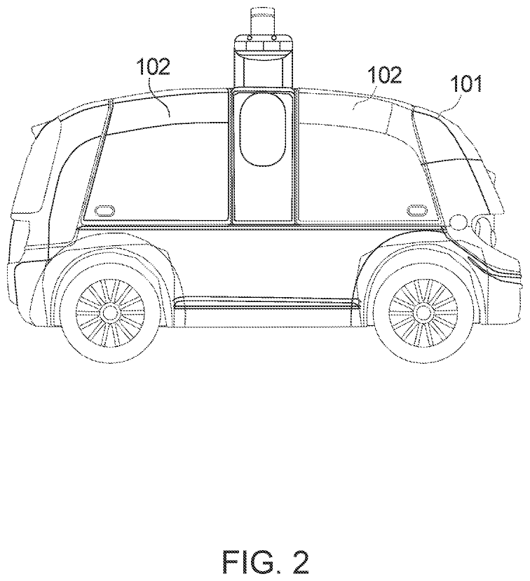

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

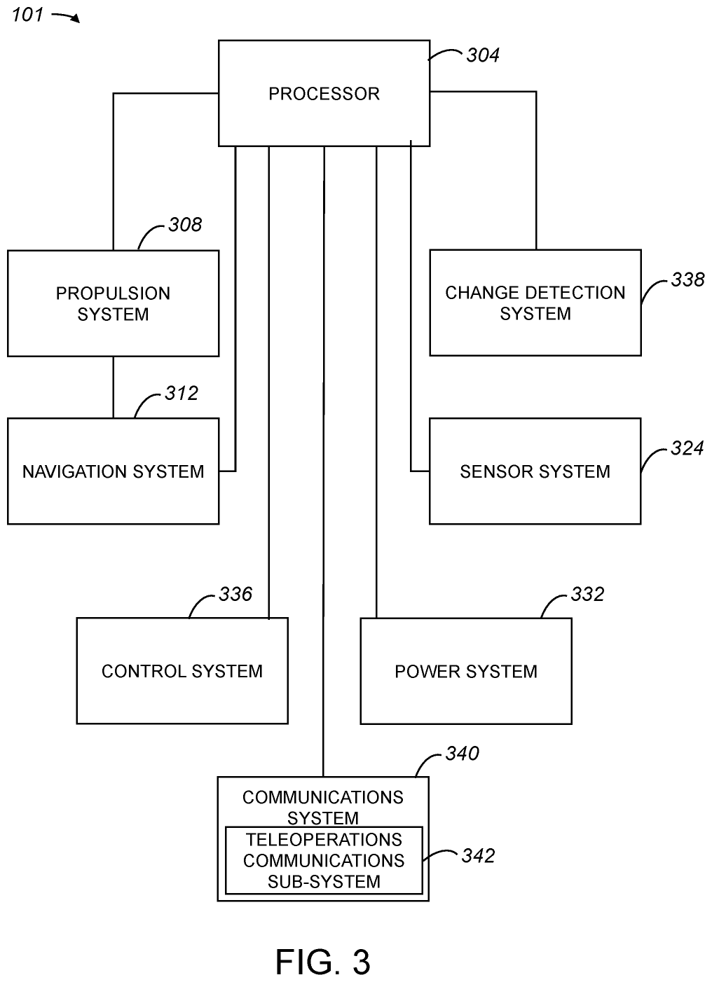

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101. In one embodiment, autonomous vehicle 101 includes a change detection system 338 which is configured to determine whether there is a difference between a context map, or a map used by autonomous vehicle 101 to navigate, and what autonomous vehicle 101 senses using sensor system 324 as autonomous vehicle 101 drives or otherwise travels.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In one embodiment, communications system 340 includes a teleoperations communications sub-system 342. Teleoperations communications sub-system 342 may include multiple modems, e.g., cellular modems such as LTE or 3G/4G/5G modems, that are arranged to cooperate to communicate with a fleet operations system (not shown) such that a teleoperations system of the fleet operations system may monitor and operate autonomous vehicle 101 remotely. It should be appreciated that teleoperations communications sub-system 342 may alternatively, or additionally, communicate substantially directly with a teleoperations system (not shown).

Change detection system 338 is configured to cooperate with other systems of autonomous vehicle 401, e.g., sensor system 324, to determine when there are changes between what autonomous vehicle 101 expects to see or to otherwise sense in its environment and what autonomous vehicle 101 actually sees or otherwise senses. By way of example, if a context map used by autonomous vehicle 101 to operate autonomously indicates that a stop sign should be present, but sensors such as a lidar and/or at least one camera of sensor system 324 does not detect the stop sign, then change detection system 338 may identify the discrepancy and effectively flag the inconsistency or discrepancy to a system such as an autonomy system (not shown).

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

In general, an ability to identify an inconsistency or a discrepancy between a context map and what vehicle 101 senses on vehicle 101 enables relatively quick action to be taken in response to the discrepancy. By way of example, if a stop sign is indicated in a context map but is not seen or otherwise sensed by vehicle 101, vehicle 101 may take at least one action with respect to the discrepancy in a timely manner. In one embodiment, vehicle 101 may slow to a stop and/or a teleoperations system may take over control of vehicle 101 when a discrepancy is identified. When an identified discrepancy is resolved, as for example by a teleoperator who uses sensors such as cameras on vehicle 101 to resolve the discrepancy, or by vehicle 101 itself, vehicle 101 may either be allowed to continue operating or may be extracted, e.g., when the discrepancy indicates that inaccuracies in a context map used by the vehicle 101 may pose a safety risk.

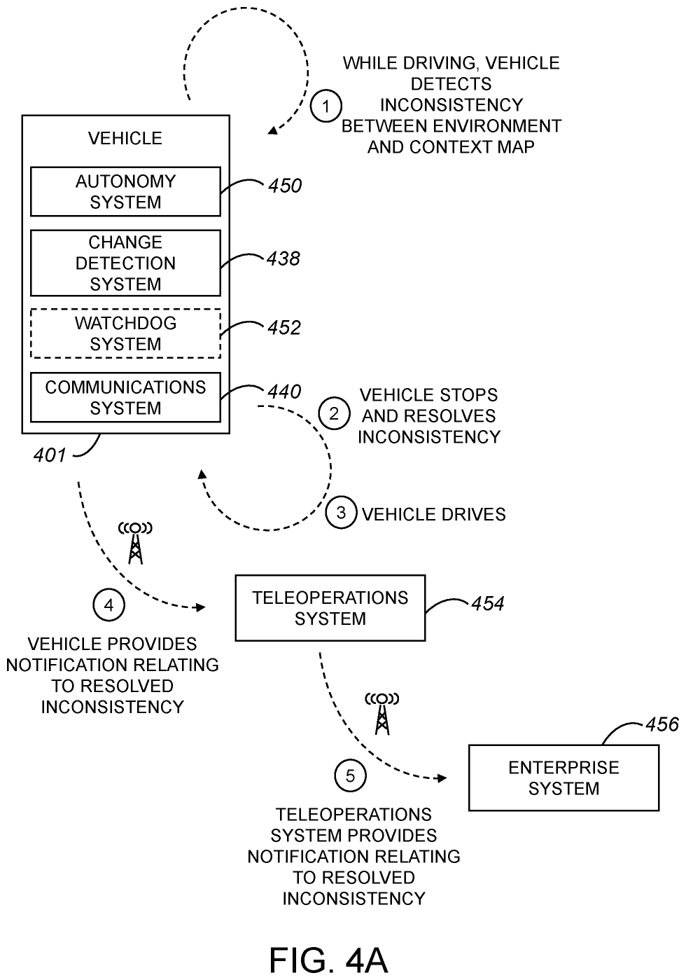

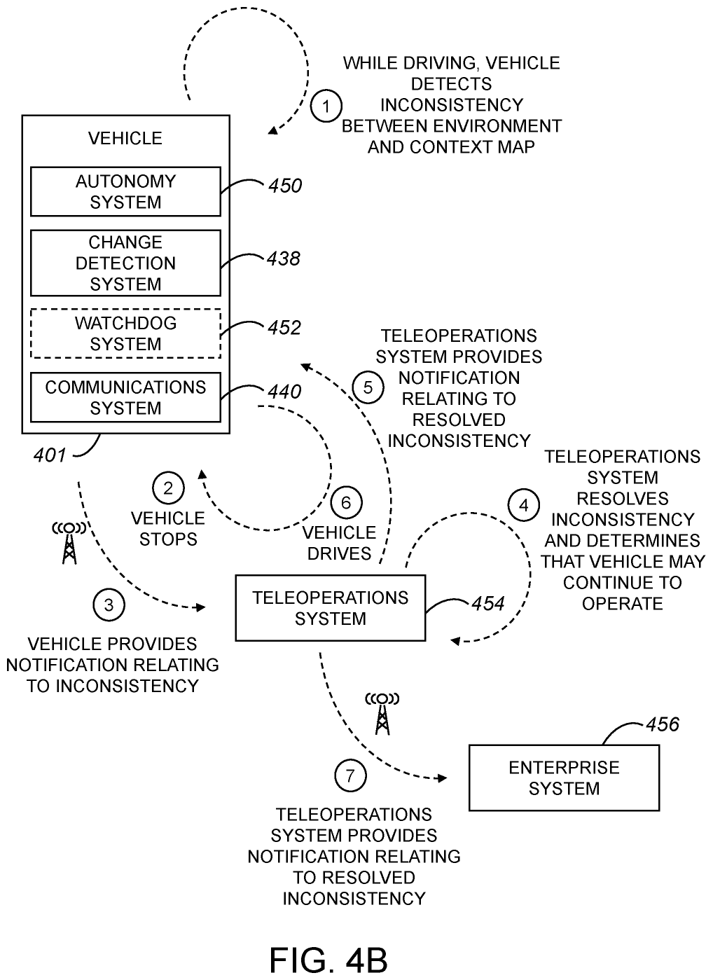

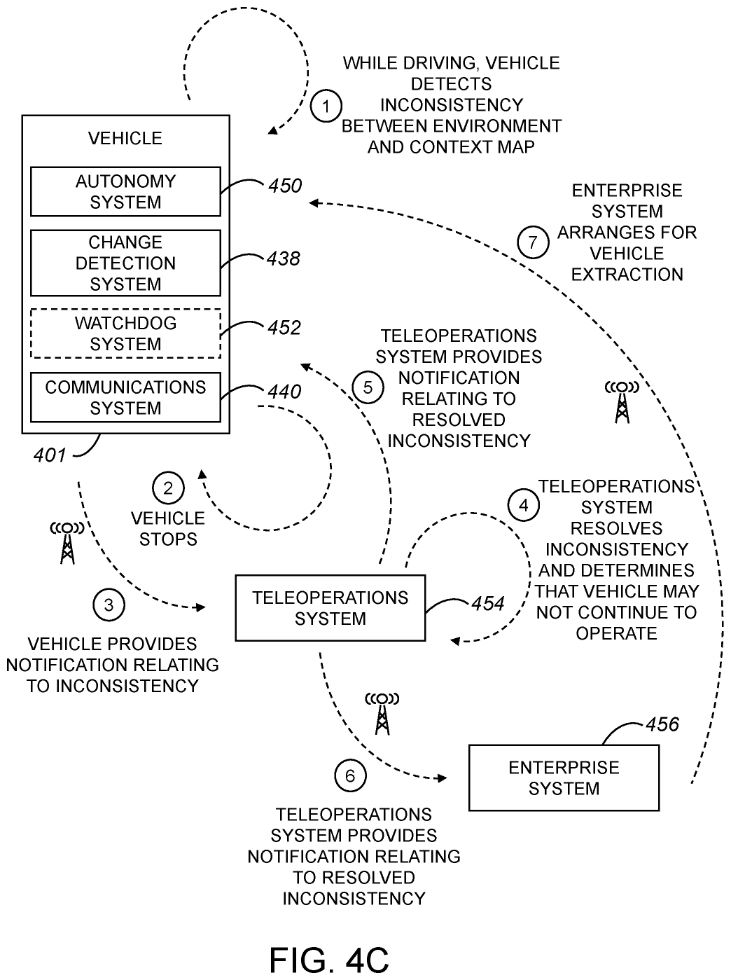

A vehicle may identify, and resolve, an inconsistency between what the vehicle senses or otherwise identified in an environment and what is indicated in a context map. In some instances, a vehicle may engage a teleoperations system for assistance in resolving an inconsistency. For example, a vehicle may effectively request that a teleoperator operating a teleoperations system or arrangement determine how to resolve an inconsistency. In other instances, a vehicle may resolve an inconsistency onboard, and may notify a teleoperations system or arrangement of the inconsistency and the resolution to the inconsistency. With reference to FIGS. 4A-C, processes associated with resolving inconsistencies will be described in accordance with embodiments.

FIG. 4A is a diagrammatic representation of a process flow associated with the identification of an inconsistency that is resolved by a vehicle in accordance with an embodiment. A vehicle 401, which generally includes systems included in vehicle 101 of FIGS. 2 and 3, has an autonomy system 450 arranged to enable vehicle 401 to operate autonomously, a change detection system 428 configured to identify inconsistencies between features sensed by vehicle 401 and features indicated in a context map, an optional watchdog system 452 which vehicle 401 may use to communicate information to autonomous system 450, and a communications system 440 which may be used to enable vehicle 401 to communicate with a teleoperations system 454. In general, teleoperations system 454 includes a controller which enables teleoperations system 454 to remotely control or to otherwise remotely command vehicle 401. Typically, a teleoperator (not shown) may use a console included in teleoperations system 454 to remotely drive vehicle 401.

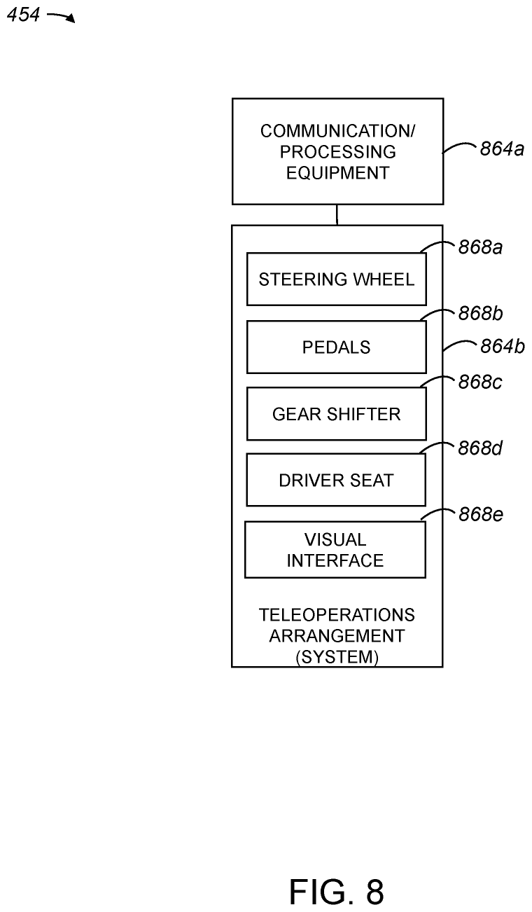

Teleoperations system 454 may be associated with part of an enterprise system 456. One embodiment of teleoperations system 454 will be discussed below with reference to FIG. 8. Enterprise system 456 may be an enterprise which manages a fleet of vehicles that includes vehicle 401, as well as teleoperations systems that include teleoperations system 454. Enterprise system 456 may be responsible for scheduling the use of vehicles, e.g., dispatching vehicles on missions, and effectively maintaining context maps. The vehicles dispatched on missions may include occupant-less and/or occupant-carrying autonomous vehicles. In one embodiment, enterprise system 456 may arrange for the extraction of disabled vehicles or vehicles which relatively unlikely to be able to safely complete missions.

At a time t1, vehicle 401 is driving and detects an inconsistency between the environment in which vehicle 401 is driving and a context map associated with autonomy system 450. By way of example, vehicle 401 may identify a stop sign in the environment that does not appear in a context map, or vehicle 401 may not see or sense a stop sign in the environment which is indicated in the context map. When the inconsistency is identified, optional watchdog system 452 may provide a notification, e.g., set a flag, that may be processed by autonomy system 450.

After identifying the inconsistency, vehicle 401 may stop driving and may resolve the inconsistency at a time t2. It should be appreciated that vehicle 401 may not necessarily stop when an inconsistency is detected and may, instead, continue operating at either substantially the same speed or a slower speed. Resolving the inconsistency may include, but is not limited to including, determining whether the inconsistency is the result of an obstructed view of the environment and determining whether the inconsistency has previously been indicated or identified.

In the described embodiment, vehicle 401 is able to resolve the inconsistency onboard. That is, change detection system 428 onboard vehicle 401 is able to essentially determine whether the context map is accurate based on the identified inconsistency. Once the inconsistency is resolved, vehicle 401 continues or resumes driving at a time t3.

At a time t4, vehicle 401 provides a notification to teleoperations system 454 that relates to the resolved inconsistency. That is, vehicle 401 informs teleoperations system 454 of the inconsistency and the resolution to the inconsistency. Information associated with the inconsistency and the resolution to the inconsistency may be displayed or rendered on a display screen of a console included in teleoperations system 454. Teleoperations system 454 may, at a time t5, notify enterprise system 456 of the inconsistency and the resolution to the inconsistency. Enterprise system 456 may use the information to update context maps that are used by vehicles including vehicle 401.

In some instances, vehicle 401 may be unable to resolve an inconsistency. Teleoperations system 454 may, in such instances, either resolve the inconsistency or determine that the inconsistency is such that vehicle 401 is to be extracted. That is, teleoperations system 454 may be used to take appropriate steps or measures to address an inconsistency in the event that vehicle 401 is unable to resolve the inconsistency.

FIG. 4B is a diagrammatic representation of a process flow associated with the identification of an inconsistency that is resolved by a teleoperations system 454 and allows for a vehicle 401 to resume operations in accordance with an embodiment. At a time t1, vehicle 401 is driving and detects an inconsistency between the environment in which vehicle 401 is driving and a context map associated with autonomy system 450. Upon detecting the inconsistency, vehicle 401 stops at a time t2. In one embodiment, when vehicle 401 stops, vehicle 401 determines that the inconsistency is to be resolved by teleoperations system 454.

At a time t3, vehicle 401 provides a notification to teleoperations system 454 relating to the detected inconsistency. Once teleoperations system 454 obtains information relating to the inconsistency from vehicle 401, teleoperations system 454 resolves the inconsistency at a time t4. By way of example, an operator may use teleoperations system 454 to monitor the environment around vehicle 401 to effectively provide a solution to the inconsistency detected by vehicle 401. The operator may also use teleoperations system 454 to navigate vehicle 401 around the inconsistency. In the described embodiment, teleoperations system 454 determines that vehicle 401 may continue to operate.

At a time t5, teleoperations system 454 provides a notification to vehicle 401 that relates to the resolved inconsistency and, at a time t6, vehicle 401 resumes driving. At a time t7, teleoperations system provides a notification to enterprise system 456 that relates to the resolved inconsistency.

Referring next to FIG. 4C, a process flow associated with the identification of an inconsistency that is resolved by teleoperations system 454 and results in vehicle 401 being extracted will be described in accordance with an embodiment. At a time t1, vehicle 401 is driving and detects an inconsistency between the environment in which vehicle 401 is driving and a context map associated with autonomy system 450. Upon detecting the inconsistency, vehicle 401 stops at a time t2. In one embodiment, when vehicle 401 stops, vehicle 401 determines that the inconsistency is to be resolved by teleoperations system 454.

At a time t3, vehicle 401 provides a notification to teleoperations system 454 relating to the detected inconsistency. Once teleoperations system 454 obtains information relating to the inconsistency from vehicle 401, teleoperations system 454 resolves the inconsistency at a time t4. In the described embodiment, teleoperations system 454 determines that vehicle 401 may not continue to operate. By way of example, teleoperations system 454 may determine that vehicle 401 is unable to operate at a desired level of safely because a context map used by autonomy system 450 may include more inconsistencies than the one identified at time t1.

At a time t5, teleoperations system 454 provides a notification to vehicle 401 relating to the resolved inconsistency. Such a notification may provide instructions for vehicle 401 to remain stopped, and may effectively inform that vehicle 401 is to be extracted, e.g., removed from the environment in which vehicle 401 is located.

Once vehicle 401 is notified of the resolved inconsistency, teleoperations system 454 provides a notification to enterprise system 456 at a time t6. The notification to enterprise system 456 relates to the resolved inconsistency, and may include an indication that vehicle 401 is to be extracted.

At a time t7, enterprise system 456 arranges for vehicle 401 to be extracted. Enterprise system 456 may dispatch another vehicle, e.g., a flat bed tow truck, to effectively pick up vehicle 401 and to transport vehicle 401 to a location such as a maintenance garage, a staging area, or another facility associated with enterprise system 456. Extracting vehicle 401 may also include dispatching an alternate vehicle to complete the mission or the task that vehicle 401 was performing when the inconsistency was identified.

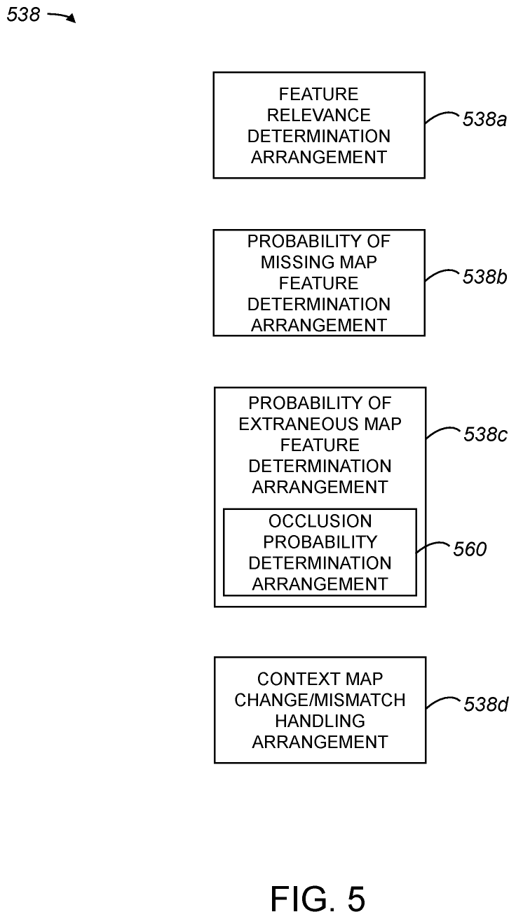

With reference to FIG. 5, a change detection system will be discussed in accordance with an embodiment. A change detection system 538 is typically onboard an autonomous vehicle, and is configured to process inconsistencies or differences associated with features in an environment and features indicated in a context map associated with the environment. Change detection system 538 includes a feature relevance determination arrangement 538a, a probability of missing map feature determination arrangement 538b, a probability of extraneous map feature determination arrangement 538c, and a context map change/mismatch handling arrangement 538d.

Feature relevance determination arrangement 538a is configured to determine whether an inconsistency, e.g., a feature, is of concern to the vehicle on which change detection system 538 is located. It should be appreciated that the feature may be a feature that is detected but is not indicated in a context map, or the feature may be a feature that is indicated in a context map but not detected. Feature relevance determination arrangement 538a may identify a feature as having a relatively high relevance if the feature is likely to have a relatively significant effect on the autonomous operation of a vehicle, and may identify a feature as having a relatively low relevance if the feature is not likely to have a significant effect on the autonomous operation of a vehicle. For example, a feature located where a stop sign may be expected in a lane that a vehicle is driving in may be considered as having a relatively high relevance, whereas a feature located where a stop sign may be expected in a lane that is not where a vehicle is driving may be considered as having a relatively low relevance. Additionally, a stop sign that is located substantially behind a vehicle may be considered to have a relatively low relevance, as a stop sign behind the vehicle is not likely to have an effect on an ability of the vehicle to operate safely. In general, feature relevance determination arrangement 538a may determine a relevance metric that is an indicator of how relevant a detected feature, or a feature that is not detected, may be to the ability of a vehicle to safely operate.

Probability of missing map feature determination arrangement 538b is configured to assess whether a feature that is not indicated in a context map is a feature that effectively should be included in the context map. That is, probability of missing map feature determination arrangement 538b determines a probability that a feature is an actual feature that may have an effect on the ability for a vehicle to drive safely. When the probability is low, then the inconsistency may not need to be resolved. When the probability is high, then the inconsistency is identified as substantially needing to be resolved. The location of the feature in the environment may provide an indication of whether the feature has a relatively high probability of being missing from the context map. In one embodiment, the probability may be based on how many frames of an image the feature appears in within a predetermined amount of time or a window of time. That is, the probability may be based on how often the feature is indicated in collected data within a particular window of time. The identification of a threshold that effectively defines a low probability, and the identification of a threshold that effectively defines a high probability may vary depending upon factors including, but not limited to including, historical information relating to empirical performance, intuition, and previous performance. Typically, a high probability may be much higher than a low probability. In one embodiment, thresholds for low and high probabilities may be based on predetermined parameters.

Probability of extraneous map feature determination arrangement 538b is configured to assess whether a feature that is indicated in a context map but does not appear to be in an actual environment should effectively be removed from the context map. When the probability is low that the feature is not likely to be in the actual environment, then the inconsistency may need to be resolved as the feature likely should be detected in an actual environment. A low probability of the feature not being in the actual environment may indicate an issue with the ability of a vehicle to accurately sense the surroundings of the vehicle. When the probability is high that the feature is not likely to be in the actual environment, then the feature may effectively be identified as an inaccuracy in the context map. In one embodiment, the probability may be based on how many frames of an image the feature does not appear in within a predetermined amount of time or a window of time. That is, the probability may be based on how often the feature is not indicated in collected data within a particular window of time.

Context map change/mismatch handling arrangement 538d is configured to use information provided by feature relevance determination arrangement 538a, a probability determined by probability of missing map feature determination arrangement 538b, and a probability determined by probability of extraneous map feature determination arrangement 538b to essentially determine how to process the feature, or how to resolve the inconsistency associated with the feature. Resolving the inconsistency associated with the feature may involve enabling a vehicle to resume autonomous driving, enabling the vehicle to be remotely driven using teleoperations to essentially account for the feature, and/or extracting the vehicle.

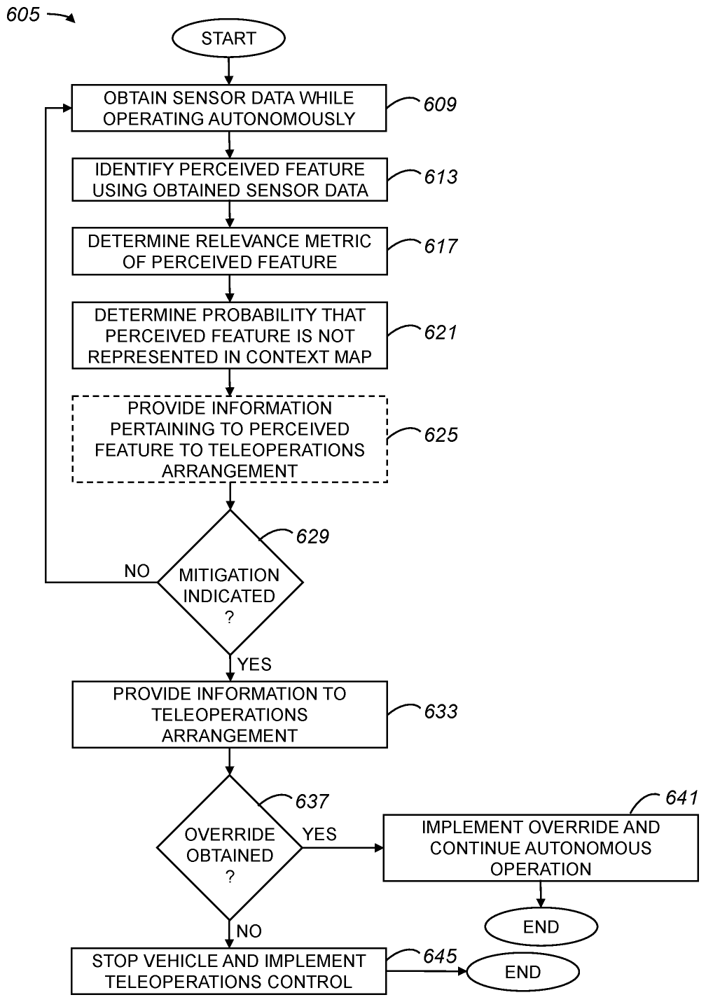

FIG. 6 is a process flow diagram which illustrates a method of identifying a missing context map feature, or a feature identified in an actual environment that is not included in the context map, in accordance with an embodiment. A method 605 of identifying a missing context map feature begins at a step 609 in which a vehicle obtains data from sensors on the vehicle. That is, the vehicle collects data as the vehicle operates autonomously within an environment. For example, the vehicle may obtain data from cameras and lidars.

In a step 613, a perceived feature is identified from the sensor data. The perceived feature may be identified using image data from one or more cameras, as well as a point cloud associated with a lidar. The perceived feature may be identified based on a location of the perceived feature and/or one or more images of the perceived feature.

Once the perceived feature is identified, a relevance metric of the perceived feature is identified in a step 617. Such a relevance metric may be determined using a feature relevance determination arrangement, e.g., feature relevance determination arrangement 538a of FIG. 5. Then, in a step 621, a probability that the perceived feature is not represented, or not accurately represented, in a context map is determined. That is, a probability that the perceived feature is not in the context map but essentially should be in the context map is identified. Such a probability may be determined using a probability of missing map feature determination arrangement, e.g., probability of missing map feature determination arrangement 538b of FIG. 5.

In one embodiment, after the probability that the perceived feature is not represented in a context map, or is missing from the context map, is determined, information pertaining to the perceived feature may optionally be provided to a teleoperations arrangement or system such that the information may be presented on a console of a teleoperations arrangement in a step 625. In such an embodiment, the teleoperations arrangement may take over operating the vehicle. When the teleoperations arrangement takes over operating the vehicle, the teleoperations arrangement may effectively determine how to address the inconsistency. In a step 629, a determination is made as to whether mitigation is to be performed in response to perceived feature. That is, it is determined whether mitigation is indicated. It should be appreciated that such a determination may be made by the vehicle or by a teleoperations arrangement.

If the determination in step 629 is that no mitigation is to be performed, the implication is that the perceived feature essentially does not have a significant adverse effect on the safe operation of the vehicle. As such, process flow returns from step 629 to step 609 in which sensor data continues to be obtained.

Alternatively, if it is determined in step 629 that a mitigating function is to be performed, the indication is that the perceived feature is actually a feature that should likely be included in a context map. In one embodiment, the determination that mitigation is indicated is effectively a determination that the existence of the feature which is not reflected in a context map may have a relatively significant effect on the safe operation of the vehicle. As such, process flow moves to a step 633 in which information is provided to a teleoperations arrangement. In one embodiment, an autonomy disengagement instruction or prompt may be provided to a console or display of a teleoperations arrangement or system.

A determination is made in a step 637 as to whether a teleoperations override is received by the vehicle. In other words, it is determined whether a teleoperations arrangement is to operate the vehicle remotely. If it is determined that an override is received by the vehicle, then the vehicle overrides the teleoperations arrangement and continues to operate autonomously in a step 641. Once the vehicle resumes operating autonomously, the method of identifying a missing context map feature is completed.

Alternatively, if it is determined in step 637 that a teleoperations override is not received, then in a step 645, the vehicle is stopped, and teleoperations control is implemented using a teleoperations arrangement. In addition, an autonomy system of the vehicle is disengaged while the teleoperations arrangement operates the vehicle remotely. The method of identifying a missing context map feature is completed once the teleoperations system effectively takes control of the vehicle.

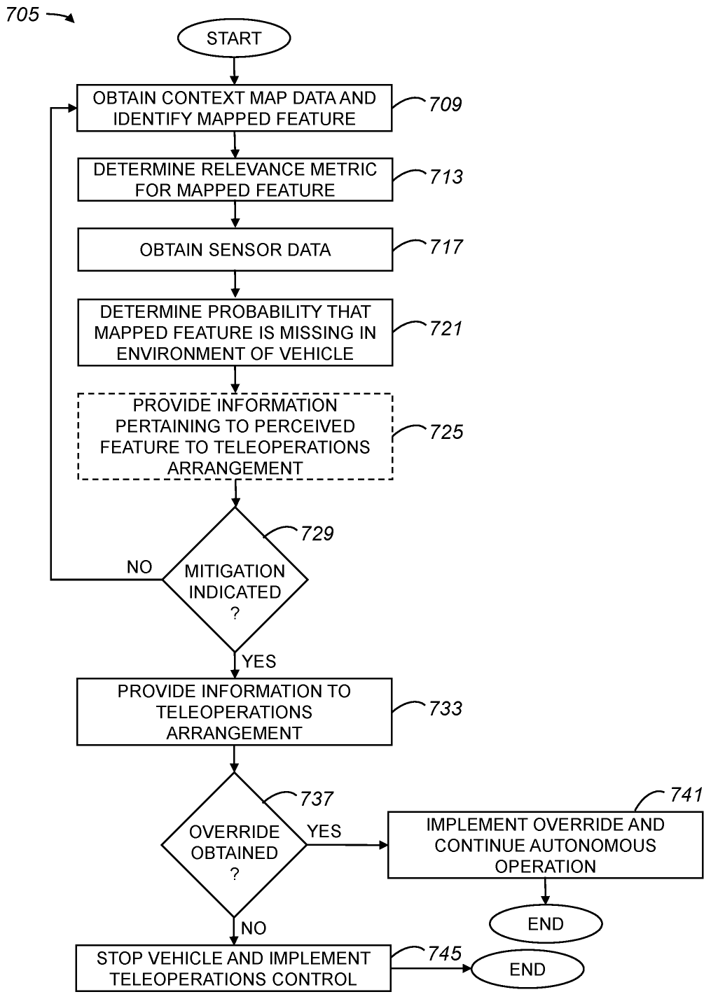

FIG. 7 is a process flow diagram which illustrates a method of identifying an extraneous context map feature in accordance with an embodiment. A method 705 of identifying an extraneous context map feature begins at a step 709 in which a vehicle operates and context map data is obtained while the vehicle operates. The obtained context map data identifies a feature, or a mapped feature. In one embodiment, the feature may be a road sign or a traffic sign.

In a step 713, a relevance metric associated with the mapped feature is calculated. Then, in a step 717, sensor data is obtained from a sensor system on the vehicle while the vehicle operates. The sensor data may include, but is not limited to including, image data from one or more cameras and point cloud data from a lidar.

From step 717, process flow moves to a step 721 in which a probability that the mapped feature is not represented in the environment of the vehicle, as indicated by sensor data, is determined. That is, a probability that the mapped feature is an extraneous feature is determined, as for example using a probability of extraneous map feature determination arrangement such as probability of extraneous map feature determination arrangement 538c of FIG. 5. In one embodiment, such a determination may include assessing whether there may be an occlusion in the environment that prevents an actual feature that corresponds to the mapped feature from being sensed. By way of example, if sensor data indicates that there is an object between the vehicle and a location at which the mapped feature is expected to be located, an actual feature at the location may be occluded.

Information pertaining to the mapped feature may optionally be provided to a teleoperations arrangement in a step 725, e.g., such that the information may be presented or rendered on a console or a display of a teleoperations arrangement in a step 725. In one embodiment, the teleoperations arrangement may take over operating the vehicle. It should be appreciated, however, that the vehicle may instead continue to operate autonomously or may come to a stop.

In a step 729, a determination is made as to whether mitigation is indicated, or whether mitigation is to be performed in response to the feature in the context map that does not appear as an actual feature. It should be appreciated that such a determination may be made by the vehicle or by a teleoperations arrangement.

If the determination in step 729 is that no mitigation is to be performed, the implication is that the existence or non-existence of the mapped feature in the environment essentially does not have a significant adverse effect on the safe operation of the vehicle. As such, process flow returns from step 729 to step 709 in which context map data is obtained and mapped features in the context map are identified.

Alternatively, if it is determined in step 729 that mitigation is indicated, the implication is that the mapped feature is effectively an indication that the context map may include a significant number of inconsistencies. Accordingly, process flow moves from step 729 to a step 733 in which an autonomy disengagement instruction or prompt may be provided to a teleoperations arrangement.

A determination is made in a step 737 as to whether a teleoperations override is received or otherwise obtained by the vehicle. If it is determined that an override is received by the vehicle, then the vehicle overrides the teleoperations arrangement and continues to operate autonomously in a step 741. Once the vehicle resumes operating autonomously, the method of identifying an extraneous context map feature is completed.

Alternatively, if it is determined in step 737 that a teleoperations override is not received or otherwise obtained, then in a step 745, the vehicle is stopped, and a teleoperations arrangement essentially takes control of the vehicle. In one embodiment, an autonomy system is disengaged while the teleoperations arrangement operates the vehicle remotely. The method of identifying an extraneous context map feature is completed once the teleoperations arrangement effectively takes control of the vehicle.

Referring next to FIG. 8, a teleoperations system, as for example teleoperations system 454 of FIGS. 4A-C, will be described in accordance with an embodiment. Teleoperations system 454 may include communication/processing equipment 864a and teleoperator or human operator system 864b which are in communication with each other. Communication/processing equipment 864a may be arranged to receive or to otherwise obtain signals from a vehicle, as for example vehicle 401 of FIGS. 4A-C, across a network. Signals may be processed by communications/processing equipment 864a to provide information that enables teleoperations operator arrangement 454 to operate the vehicle remotely. In one embodiment, information provided may include contextual information associated with a vehicle that teleoperations operator arrangement 454 may utilize when remotely controlling the vehicle. Communication/processing equipment 864a may also send or otherwise provide signals to the vehicle, as for example signals that include instructions to operate the vehicle.

Teleoperator or human operator system 864b generally includes controls and other equipment which enable a remote human to drive or to otherwise control a vehicle. Teleoperator or human operator system 864b may generally include a steering wheel 868a, pedals 868b, a gear shifter 868c, a driver seat 868d, and a visual interface 868e. Visual interface 868e may include one or more display screens configured to display one or more images associated with the environment within which a vehicle monitored or controlled using teleoperations system 454 is operating. For example, visual interface 868e may display or otherwise render images associated with the environment around a vehicle such that an operator of teleoperations system 454 may determine the disposition of an inconsistency with a context map.

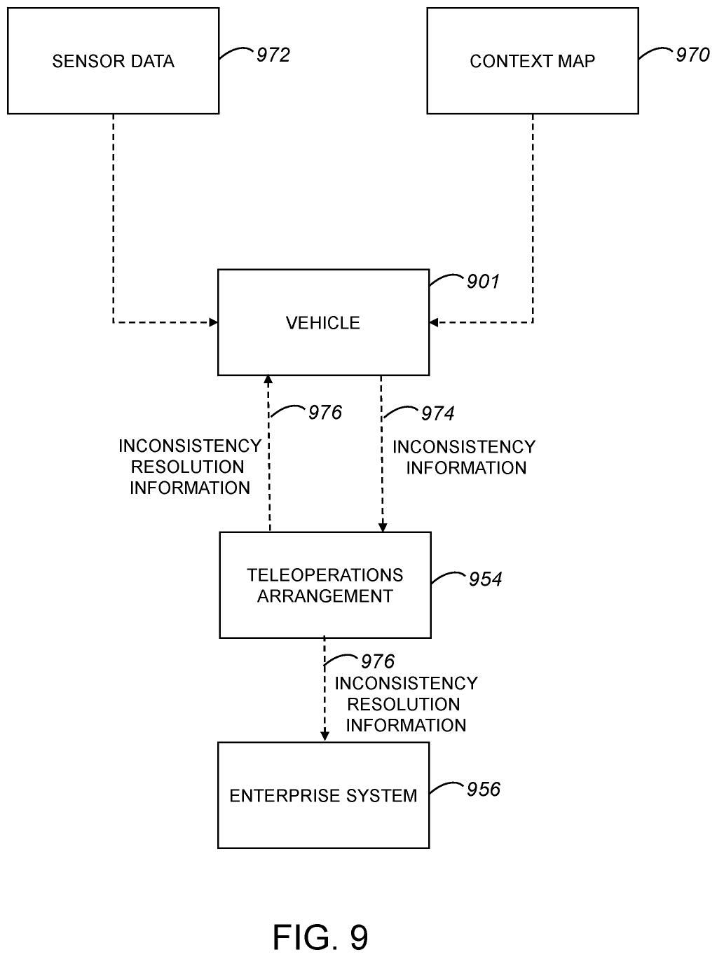

As described above, in some embodiments, a vehicle may identify an inconsistency between a context map and an actual environment within which the vehicle is operating, and a teleoperations arrangement may essentially resolve the inconsistency and provide commands to be followed by the vehicle in response to the inconsistency. FIG. 9 is a diagrammatic representation of an overall system within which inconsistencies between an actual environment and a context map are identified and processed in accordance with an embodiment. A vehicle 901 may, while operating autonomously or in an autonomous mode, collect sensor data 972 obtained by sensors included on vehicle 901. Sensor data 972 may generally provide a view or representation of an environment within which vehicle 901 is operating. Vehicle 901 may compare sensor data 972 to a context map 970 associated with the environment. Context map 970 provides a description of the environment within which vehicle 901 is operating.

As vehicle 901 operates, vehicle 901 may essentially compare sensor data 972 to context map 970. A comparison of sensor data 972 with context map 970 may result in a determination that there is at least one inconsistency between sensor data 972 and context map 970. For example, an inconsistency may be that sensor data 972 identifies a feature that does not appear in context map 970, or an inconsistency may be that a feature which appears in context map 970 is not identified in sensor data 972.

Upon identifying an inconsistency, vehicle 901 may process the inconsistency and may provide inconsistency information 974 to a teleoperations arrangement 954 substantially in real-time, or while vehicle 901 is operating. Processing the inconsistency may include, but is not limited to including, determining a relevance metric for the inconsistency, determining a probability that the inconsistency is a feature that is missing from the context map, and/or determining a probability is an extraneous feature in the context map. Inconsistency information 974 may be provided to teleoperations arrangement 954 such that teleoperations arrangement 954 may determine how to resolve the inconsistency. In one embodiment, a teleoperator operating teleoperations arrangement 964 may review inconsistency information 974 displayed on a display screen of teleoperations arrangement 954 to determine how to resolve the inconsistency.

Once it is determined using teleoperations arrangement 954 how to resolve the inconsistency, teleoperations arrangement 954 provides inconsistency resolution information 976 to vehicle 901. Inconsistency resolution information 976 may include, but is not limited to including, an instruction for vehicle 901 to come to a stop, an instruction for vehicle 901 to disengage an autonomy system, an instruction for vehicle 901 to engage an autonomy system, and/or an instruction for vehicle 901 to operate under the control of teleoperations arrangement 954.

Teleoperations arrangement 954 may also provide inconsistency resolution information 976 to an enterprise system 956 which is associated with a fleet that includes vehicle 901. Enterprise system 956 may use inconsistency resolution information 976 to determine whether context map 970 is to be updated for the use of substantially all vehicles associated with an enterprise. In one embodiment, enterprise system 956 may also determine whether to propagate inconsistency resolution information 976 to other vehicles within a fleet substantially in real-time.

As mentioned above, in some situations, a vehicle may identify an inconsistency or discrepancy between an actual environment and a context map, and the vehicle may resolve the inconsistency itself and take an action based on the resolution of the inconsistency. By way of example, if the vehicle identifies a stop sign in an actual environment that is not indicated in a context map associated with the environment, the vehicle may determine that the stop sign exists and cause an autonomy system onboard the vehicle to operate based on an existence of the stop sign. In one embodiment, when a vehicle resolves an inconsistency, it should be appreciated that the vehicle may elect not to inform a teleoperations arrangement of the inconsistency and associated resolution. For instance, the vehicle may not have an associated teleoperations arrangement to inform or to otherwise notify.

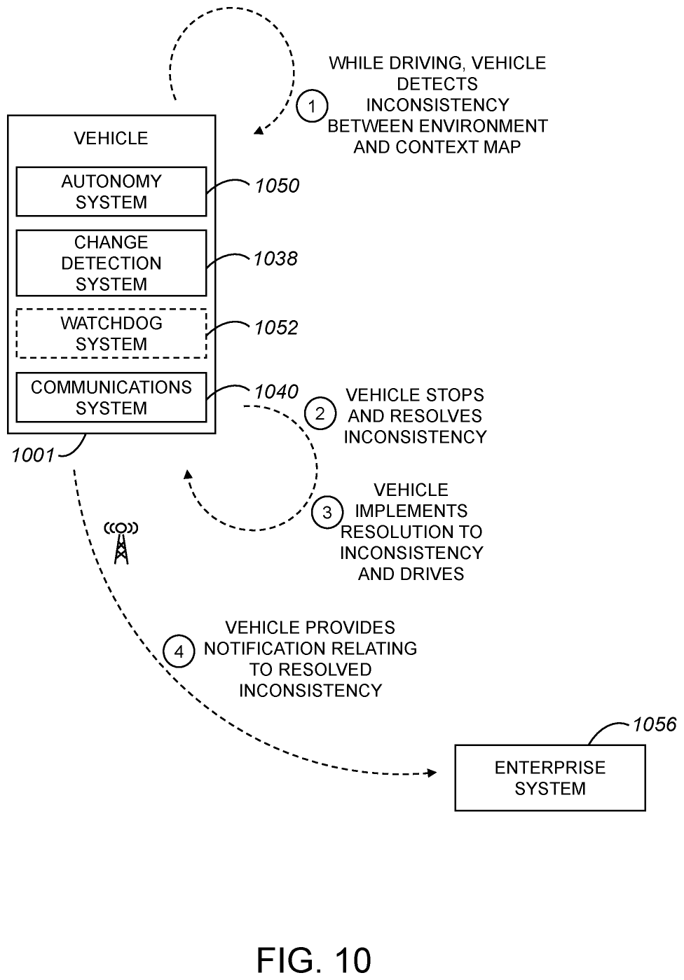

FIG. 10 is a diagrammatic representation of a process flow associated with the identification of an inconsistency that is resolved by a vehicle that is part of an enterprise that does not include a teleoperation arrangement or system in accordance with an embodiment. An enterprise includes a vehicle 1001 and an enterprise system 1056. Vehicle 1001 includes an autonomy system 1050, a change detection system 1038, an optional watchdog system 1052, and a communications system 1040.

At a time t1, vehicle 1001 operates and detects an inconsistency between the environment within which vehicle 1001 is operating and a context map that essentially depicts the environment. The inconsistency may be the existence of a feature indicated in data collected by vehicle 1001 that is not indicated in the context map, or the inconsistency may be the lack of a feature indicated in data collected by vehicle 1001 that is indicated in the context map.

At a time t2, the vehicle stops and resolves the inconsistency. That is, the vehicle may come to a stop while determining a resolution to mitigate the existence of the inconsistency. Once the consistency is resolved, the vehicle implements the resolution to the inconsistency at a time t3 and drives. In one embodiment, implementing the resolution may include providing the resolution to autonomy system 1050 such that autonomy system 1050 may autonomously operate vehicle 1001 based at least in part on the resolution.

Enterprise system 1056 may be notified by vehicle 1001 at a time t4 about the resolved inconsistency. Vehicle 1001 may provide information about the inconsistency and the resolution to the inconsistency to enterprise system 1056 such that enterprise system 1056 may determine whether to update context maps, to notify other vehicles (not shown) that are part of the enterprise, etc.

Although only a few embodiments have been described in this disclosure, it should be understood that the disclosure may be embodied in many other specific forms without departing from the spirit or the scope of the present disclosure. By way of example, inconsistencies which are resolved with respect to a vehicle driving in a particular environment may effectively be shared with other vehicles which may drive in that particular environment. That is, maps provided to other vehicles may be substantially updated based on an inconsistency resolved by a particular vehicle. Such sharing of information within a fleet of vehicles enables the fleet of vehicles to operate more efficiently.

In one embodiment, computer-implemented method includes obtaining sensor data from sensors onboard a vehicle while the vehicle is operating in an autonomous mode. While the vehicle is operating in autonomous mode, the vehicle may be remotely monitored by an operator via a teleoperations console of a teleoperations system. The method includes identifying, based on the sensor data, a perceived feature in the environment of the vehicle. For the perceived feature, a relevance metric and a probability that the perceived feature is not represented within a context map may be determined. The method also includes presenting, within a user interface displayed on the teleoperations console monitoring the vehicle, information relating to the perceived feature, wherein presenting the information relating to the perceived feature is based on the determined relevance metric and the probability that the perceived feature is not represented within the context map.

A system that resolves inconsistencies between an actual environment that a vehicle is operating in and a context map has generally been described as being onboard the vehicle. It should be appreciated that such a system is not limited to being onboard a vehicle, and may instead be remote with respect to a vehicle. When a system that resolves inconsistencies is not onboard a vehicle, the vehicle may provide information that enables the system to resolve the inconsistencies and, upon resolving the inconsistencies, the system provide the vehicle with instructions associated with the resolution of the inconsistencies. For example, if there is insufficient computing power onboard a vehicle to enable change detection or processing context map inconsistencies to be performed, the change detection functionality may be implemented offboard or remotely with respect to the vehicle. In one embodiment, if it is determined that change detection functionality is not critical for the safe operation of a vehicle. e.g., because there is a driver present in the vehicle, the change detection functionality may be offboard.

In one embodiment, upon identifying an inconsistency or discrepancy between an actual environment and a context map that represents the environment, a vehicle may determine a resolution to the inconsistency and cause an autonomy system of the vehicle to autonomously operate the vehicle based on the determined resolution. In general, the vehicle may not update the context map, or cause the context map to be updated, based on the determined resolution, substantially in real-time. However, it should be understood that in some situations, the vehicle may either update the context map in real-time or cause the context map to be updated substantially in real-time.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. For instance, a vehicle may be stopped upon identifying an inconsistency between an actual environment and a context map, a vehicle may continue to operate autonomously unless it is determined that a teleoperations system is to take over control of the vehicle, or a vehicle may be operated by a teleoperations system until an inconsistency is resolved. Therefore, the present examples are to be considered as illustrative and not restrictive, and the examples are not to be limited to the details given herein, but may be modified within the scope of the appended claims.

What is claimed is:

1. A method comprising:
operating a vehicle in a first environment, the vehicle including a change detection system and at least one sensor configured to obtain data associated with the first environment, wherein operating the vehicle in the first environment includes obtaining the data associated with the first environment using the at least one sensor;
obtaining a context map associated with the first environment;
comparing, using the change detection system, the data associated with the first environment and the context map to identify at least a first inconsistency between the data associated with the first environment and the context map;
determining, while the vehicle is operating, a resolution for the first inconsistency; and
taking an action based on the resolution, wherein the action is taken by the vehicle.

2. The method of claim 1 wherein operating the vehicle in the first environment includes autonomously operating the vehicle in the first environment, and wherein comparing the data associated with the first environment and the context map to identify the first inconsistency includes determining at least one probability associated with an existence of the first inconsistency.

3. The method of claim 2 wherein the first inconsistency is a first feature that is identified in the data associated with the first environment and is not included in the context map, and wherein the at least one probability is a first probability that the first feature is not represented in the context map.

4. The method of claim 2 wherein the first inconsistency is a second feature that is represented in the context map and is not identified in the data associated with first environment, and wherein the at least one probability is a second probability that the feature is missing from the first environment.

5. The method of claim 2 wherein comparing the data associated with the first environment and the context map to identify the first inconsistency further includes determining a relevance metric associated with the first inconsistency.

6. The method of claim 2 further including:
providing information associated with the first inconsistency to a teleoperations arrangement, wherein determining, while the vehicle is operating, the resolution for the first inconsistency includes determining the resolution at the teleoperations arrangement.

7. The method of claim 6 wherein the resolution includes the action, the method further including:
obtaining, at the vehicle, an instruction from the teleoperations arrangement, the instruction arranged to specify the action, the action being at least one selected from a group including continuing autonomously operating the vehicle, stopping the vehicle, and enabling the vehicle to be operated by the teleoperations arrangement.

8. A vehicle including logic encoded in one or more tangible non-transitory, computer-readable media for execution and when executed operable to:
operate the vehicle in a first environment, the vehicle including a change detection system and at least one sensor configured to obtain data associated with the first environment, wherein the logic operable to operate the vehicle in the first environment is further operable to obtain the data associated with the first environment using the at least one sensor;
obtain a context map associated with the first environment;
compare, using the change detection system, the data associated with the first environment and the context map to identify at least a first inconsistency between the data associated with the first environment and the context map;
determine, while the vehicle is operating, a resolution for the first inconsistency; and
take an action based on the resolution, wherein the action is taken by the vehicle.

9. The logic of claim 8 wherein the logic operable to operate the vehicle in the first environment includes logic operable to autonomously operate the vehicle in the first environment, and wherein the logic operable to compare the data associated with the first environment and the context map to identify the first inconsistency is operable to determine at least one probability associated with an existence of the first inconsistency.

10. The logic of claim 9 wherein the first inconsistency is a first feature that is identified in the data associated with the first environment and is not included in the context map, and wherein the at least one probability is a first probability that the first feature is not represented in the context map.

11. The logic of claim 9 wherein the first inconsistency is a second feature that is represented in the context map and is not identified in the data associated with first environment, and wherein the at least one probability is a second probability that the feature is missing from the first environment.

12. The logic of claim 9 wherein the logic operable to compare the data associated with the first environment and the context map to identify the first inconsistency is further operable to determine a relevance metric associated with the first inconsistency.

13. The logic of claim 9 further operable to:
provide information associated with the first inconsistency to a teleoperations arrangement; and
obtain the resolution from the teleoperations arrangement.

14. The logic of claim 13 wherein the resolution includes the action, the logic further operable to:
obtain, at the vehicle, an instruction from the teleoperations arrangement, the instruction arranged to specify the action, the action being at least one selected from a group including continuing autonomously operating the vehicle, stopping the vehicle, and enabling the vehicle to be operated by the teleoperations arrangement.

15. A framework comprising:
at least a first vehicle, the first vehicle including a change detection system and at least one sensor configured to obtain data while the first vehicle operates, the first vehicle further arranged to access a context map, wherein the change detection system arranged to compare the data to the context map to identify a first inconsistency;
a teleoperations arrangement, the teleoperations arrangement configured to monitor the first vehicle, wherein the first vehicle is arranged to provide information associated with the first inconsistency to the first vehicle, the teleoperations arrangement further being configured to determine a first resolution to the first inconsistency and to provide the first resolution to the first vehicle, the first vehicle further being arranged to take an action in response to the first resolution; and
an enterprise system, the enterprise system configured to maintain the context map, wherein the teleoperations arrangement is arranged to provide the information associated with the first inconsistency and the first resolution to the enterprise system.

16. The framework of claim 15 wherein the first vehicle includes an autonomy system arranged to enable the first vehicle to operate autonomously, and wherein the action is one selected from a group including autonomously operating the first vehicle, stopping the first vehicle, and enabling the first vehicle to be operated by the teleoperations arrangement.

17. The framework of claim 15 wherein the data is obtained while the first vehicle is operating a first environment, the first inconsistency being a first feature that is identified in the data and is not included in the context map, and wherein the change detection system arranged to compare the data to the context map to identify a first inconsistency by calculating a first probability that the first feature is not represented in the context map.

18. The framework of claim 15 wherein the data is obtained while the first vehicle is operating a first environment, the first inconsistency being a first feature that is included in the context map and is not identified in the data, and wherein the change detection system arranged to compare the data to the context map to identify a first inconsistency by calculating a first probability that the first feature is not present in the first environment.

19. The framework of claim 15 wherein the change detection system is arranged to compare the data and the context map to identify the first inconsistency by determining a relevance metric associated with the first inconsistency.

20. The framework of claim 15 wherein the enterprise system is arranged to use the information associated with the first inconsistency and the first resolution to determine whether to update the context map.
